(19) United States
(12) Patent Application Publication
(10) Pub. No.: US 2009/0136071 A1
(43) Pub. Date: May 28, 2009

(54) Connector for fastening a wearing hook to a hearing apparatus

(76) Inventor: Michael Sattler, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/291,445

(22) Filed: Nov. 10, 2008

(30) Foreign Application Priority Data
Nov. 12, 2007 (DE) 10 2007 053 754.0

(51) Int. Cl. H04R 25/00

(52) U.S. Cl. 381/330

(57) ABSTRACT

A hearing apparatus with a housing shell and a connector are provided. The connector, having a tubular base body, allows a wearing hook to fasten a hearing apparatus. A first fastening element is at a first end of the base body for fastening the wearing hook. A second fastening element is on or in the vicinity of the second end of the base body for fastening to a frame of the hearing apparatus. A third fastening element is located between the first and the second fastening element on the base body and is used to fasten a housing shell of the hearing apparatus. The housing shell thus need not be directly fastened to the frame, so that the frame can be designed to be smaller and slimmer.

### CROSS REFERENCE TO RELATED APPLICATIONS

This application claims priority of German application No. 102007053754.0 DE filed Nov. 12, 2007, which is incorporated by reference herein in its entirety.

### FIELD OF INVENTION

The present invention relates to a connector for fastening a wearing hook to a hearing apparatus having a tubular base body, a first fastening element on one end of the base body for fastening the wearing hook and a second fastening element on or in the vicinity of the second end of the base body. The present invention also relates to a hearing apparatus with a connector of this type. The term “hearing apparatus” is understood here to mean in particular a hearing device, a headset, earphones and suchlike.

### BACKGROUND OF INVENTION

Hearing devices are wearable hearing apparatuses which are used to assist the hard-of-hearing. In order to accommodate numerous individual requirements, various types of hearing devices are available such as behind-the-ear (BTE) hearing devices, hearing device with external receiver (RIC: receiver in the canal) and in-the-ear (ITE) hearing devices, for example also concha hearing devices or completely-in-the-canal (ITE, CIC) hearing devices. The hearing devices listed as examples are worn on the outer ear or in the auditory canal. Bone conduction hearing aids, implantable or vibrotactile hearing aids are also available on the market. The damaged hearing is thus stimulated either mechanically or electrically.

The key components of hearing devices are principally an input converter, an amplifier and an output converter. The input converter is normally a receiving transducer e.g. a microphone and/or an electromagnetic receiver, e.g. an induction coil. The output converter is most frequently realized as an electroacoustic converter e.g. a miniature loudspeaker, or as an electromechanical converter e.g. a bone conduction hearing aid. The amplifier is usually integrated into a signal processing unit. This basic configuration is illustrated in FIG. 1 using the example of a behind-the-ear hearing device. One or a plurality of microphones 2 for recording ambient sound are built into a hearing device housing 1 to be worn behind the ear. A signal processing unit 3 which is also integrated into the hearing device housing 1 processes and amplifies the microphone signals. The output signal for the signal processing unit 3 is transmitted to a loudspeaker or receiver 4, which outputs an acoustic signal. Sound is transmitted through a sound tube, which is affixed in the auditory canal by means of an otoplastic, to the device wearer's eardrum. Power for the hearing device and in particular for the signal processing unit 3 is supplied by means of a battery 5 which is also integrated in the hearing device housing 1.

In many cases, hearing devices have a frame, in which the signal processing components, like for instance microphone, receiver, amplifying chip and suchlike, are fastened. This not only has assembly advantages, since the frame openings are easily accessible from the outside, but also design advantages, since the housing shells fastened to the frame can exhibit different shapes and colors. The frame concept nevertheless also allows housing shells to be exchanged in a simple fashion.

Because the housing shells have to be fastened to the frame, regions with corresponding material thicknesses are to be provided in the frame, which allow the device shells to be fastened. This nevertheless generally results in voluminous configurations, since the connections between the frame and the housing shells have to be mechanically stable.

The aim of structuring a hearing apparatus is conventionally to design the device, e.g. a BTE hearing device, to be as slim as possible.

The publication DE 89 08 003 U1 discloses a housing for a hearing device to be worn behind the ear. Here a housing frame is provided, onto which two housing covers can be screwed.

The publication DE 42 30 308 C1 likewise also discloses a hearing device to be worn behind the ear with a housing frame. A mounting bracket is molded to this housing frame.

The publication DE 103 33 293 A1 finally discloses a connector for hearing device wearing hooks. The connector has a thread, in order to screw on a wearing hook. The connector also has a stop, which is used for sealing in respect of a wearing hook and to receive leverage forces. The connector finally also has a connecting lug for fixing into the housing of a hearing device.

### SUMMARY OF INVENTION

The object of the present invention thus consists in being able to configure a hearing apparatus, which is manufactured in the frame mode of construction and has housing shells, to be as small and as thin as possible.

This object is achieved in accordance with the invention by a connector for fastening a wearing hook to a hearing apparatus with a tubular base body, a first fastening element on one end of the base body for fastening the wearing hook and a second fastening element on or in the vicinity of the second end of the base body for fastening to a frame of the hearing apparatus as well as a third fastening element, which is arranged between the first and the second fastening element on the base body and is used to fasten a housing shell of the hearing apparatus.

It is thus advantageously possible to assign an additional functionality to the connector for the wearing hook, namely the possibility of fastening a housing shell and/or housing shell halves. Additional material thus need not be especially provided on the tip of a frame of the hearing apparatus in order to fasten the housing shells.

The first fastening element may form part of a snap-fit or plug-in system, with which the wearing hook can be snap-fitted or plugged into the connector. Such connecting systems allow a wearing hook to be easily exchanged if necessary.

Alternatively, the first fastening element can have a thread, with which the wearing hook can be screwed onto the connector. The screw connection represents an extremely stable and thus detachable connection variant of the wearing hook on the hearing apparatus.

The second fastening element can also have at least one flange, in order to pin or otherwise fasten the connector to a frame of the hearing apparatus. The connector can in this way be very easily fastened into the frame of the hearing apparatus.

According to a preferred alternative embodiment, the second fastening element has a collar, which can be injection-molded or glued into the frame of the hearing apparatus. The injection-molding or gluing process results in a very stable mounting of the connector in the frame. The collar also provides for torsional strength.

It is also preferable for the third fastening element to have a flange. This allows the housing shell and/or the housing shell halves to be easily attached to the connector by means of pinning for instance.

It is also advantageous if the connector is manufactured from a metal or ceramic. These materials grant sufficient mechanical stability to the connector. They can also be easily injection-molded into a plastic frame of the hearing apparatus.

The connector can also be formed in two pieces, with two tubular parts, which form the base body, being fastened into or onto one another at an angle of less than 180°. This two piece design can prove advantageous with the manufacture of the connector, since this is generally embodied as an arched and/or angular tubular piece and the bending step can be dispensed with as a result of the two-piece configuration.

As was already indicated above, it is particularly advantageous to provide a hearing apparatus and in particular a hearing device with a frame, in which signal processing components are fastened, and a housing shell additionally with an aforedescribed connector. The connector is then fastened to the wearing hook using the first fastening element, to the frame using the second fastening element and to the housing shell using the third fastening element. It is particularly advantageous if the second fastening element has a collar and is injection-molded or glued into the frame and the third fastening element also has a flange, to which the housing shell is pinned or fastened in another way.

### BRIEF DESCRIPTION OF THE DRAWINGS

The present invention is described in more detail with reference to the appended drawings, in which;

FIG. 1 shows the basic design of a hearing device according to the prior art;

FIG. 2 shows a perspective view of a connector according to a first embodiment of the present invention;

FIG. 3 shows a sectional view through one part of a hearing device with the connector in FIG. 2;

FIG. 4 shows a side view of the exemplary embodiment of FIG. 2;

FIG. 5 shows a side view of a connector according to a second embodiment and

FIG. 6 likewise shows a side view of a third exemplary embodiment of a connector.

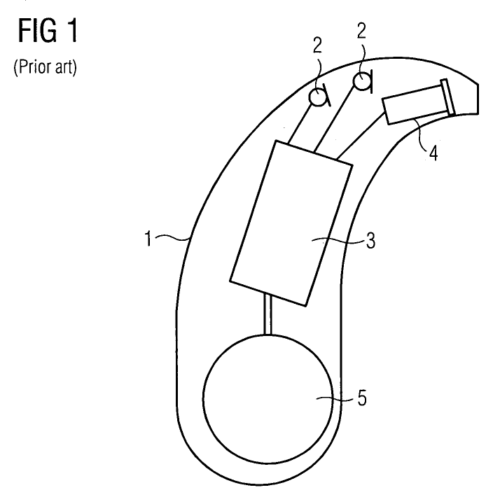

### DETAILED DESCRIPTION OF INVENTION

The exemplary embodiments illustrated in further detail below represent preferred embodiments of the present invention.

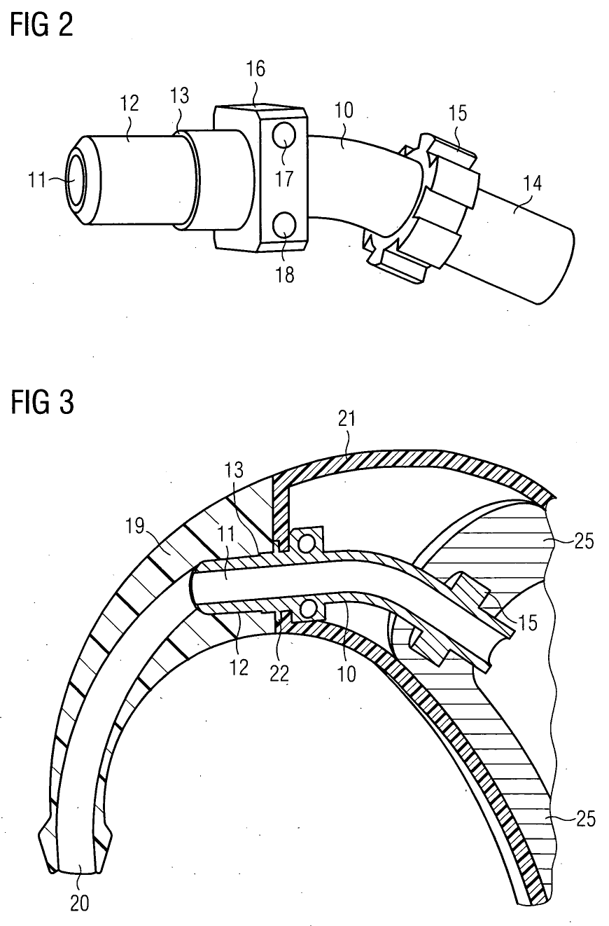

The perspective representation of the connector in FIG. 2 according to a first embodiment of the present invention has a tubular base body 10. The connector is used to transmit sound from the receiver of a BTE hearing device to a wearing hook. To this end, the sound aperture 11, in other words the tube interior, is provided. A clip-on region 12 is located on the front side, i.e. left in FIG. 2, as a first fastening element for clipping on a wearing hook. If necessary, this region 12 can also be provided with a thread, so that the wearing hook can be screwed on here. The clip-on region 12 has an approximately smaller diameter here than the conventional tube, thereby resulting in a circumferentially small shoulder 13 on its end. This delimits the clip-on depth of the wearing hook.

A collar 15 is located in the vicinity of the end 14 of the tubular base body 10 which lies opposite to the clip-on region 12. It can be pressed onto the tubular base body or formed in one piece therewith. It can essentially be replaced by any type of flange and is used as a second fastening element for fastening to a frame of the hearing apparatus and/or hearing device.

A third fastening element, here a flange 16, is also positioned between the clip-on region 12 and the collar 15, in other words between the first fastening element and the second fastening element. This flange 16 is used to fasten a device shell and/or device shell halves. To this end, the flange 16 has two boreholes 17, 18, into which corresponding pins can be inserted. Alternatively, the flange itself can also have one or several pins and/or snap-fit elements.

It is also apparent that the tubular base body 10 is curved and/or bent in the middle. This thus derives from the fact that the receiver of a hearing device is generally positioned at a point which can be better reached using a curved connector.

FIG. 3 shows the connector in FIG. 2 when in an installed state. The figure nevertheless only shows one part of the hearing device including the wearing hook 19. A sound channel 20 runs inside the wearing hook 19, said sound channel continuing the sound aperture 11 of the connector. A sound tube (not shown) is plugged onto the wearing hook on the free end of the wearing hook in order to conduct the sound produced by the hearing device to the auditory canal.

The wearing hook 19 is plugged onto the clip-on region 12 of the connector and abuts the shoulder 13. The connector with its collar 15 is injection-molded and/or glued into a hearing device frame 25 on the other side. The flange 16 is used to fasten a hearing device shell 21 to the connector and thus also to fasten the hearing device shell 21 to the frame 25 of the hearing device. For better fastening and sealing purposes, the connector in FIG. 3 also has an annular protrusion 22 in addition to the connection in FIG. 2. An annular recess is formed between said protrusion and the flange 16, into which the front side of the hearing device shell 21 is inserted. The hearing device shell 21 is typically made of two housing shell halves, which are then held in the holes 17 and/or on the frame 25 by means of pins (not shown in FIG. 3).

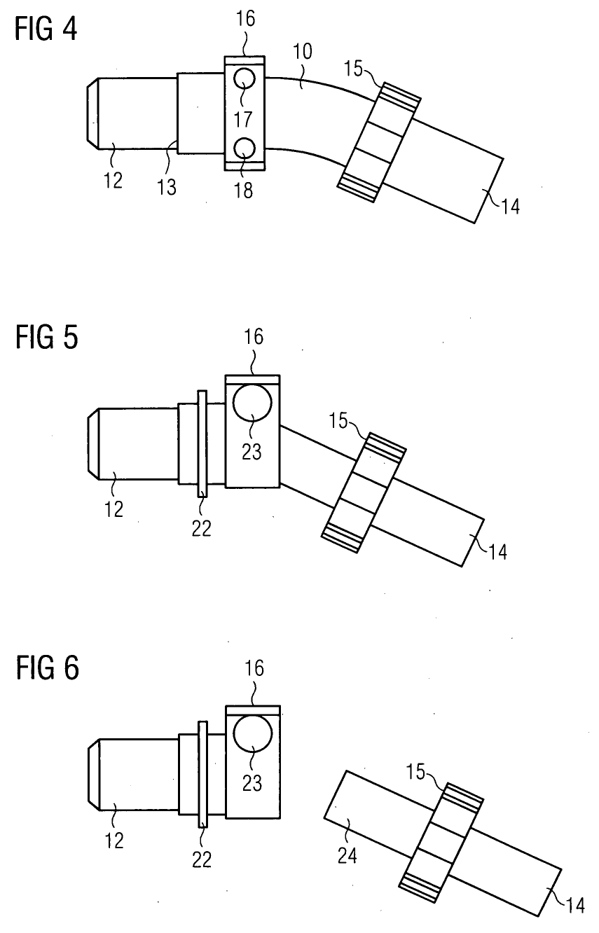

FIG. 4 once again shows a side view of the connector in FIG. 2, in order to be able to make a better comparison with additional exemplary embodiments. The individual components are provided with the same reference characters and are explained in conjunction with FIG. 2.

FIG. 5 shows a side view of a second exemplary embodiment of an inventive connector. The difference between the first exemplary embodiment in FIG. 4 essentially consists in the right part of the tubular base body 10 seamlessly opening out on the one hand at an angle into the left part. The flange 16 is also embodied here slightly differently and is only provided with a single but nevertheless larger hole 23. An annular increase 22, like in the example in FIG. 3, is also shown between the flange 16 and the clip-on region 12 in this exemplary embodiment.

A side view of a third exemplary embodiment of an inventive connector is likewise shown in FIG. 6. The connector is in two pieces here which can be plugged into one another. In the assembled state, it is practically identical to the second exemplary embodiment according to FIG. 5. For joining purposes, an oblique hole is provided in the flange 16, into which hole the tubular half 24 can be plugged. This two-piece configuration of the connector has manufacturing-related advantages in some instances if the one part can namely be favorably produced as a turning work piece and the other has to be manufactured slightly more expensively as a rotary milled part.

The afore-illustrated connectors are expediently produced from a metal. Metal connectors have proven to be acoustically favorable by virtue of their weight. Metals are nevertheless also advantageous in that the connectors produced therefrom can be stable and small. The same applies to connectors made from ceramics and/or injection ceramics.

The afore-described connector, to which a housing shell and/or housing shell halves are fastened, as a whole provides for a slimmer design of a hearing apparatus and/or hearing device, which is developed with a frame.

1.-10. (canceled)

11. A connector for fastening a wearing hook to a hearing apparatus, comprising:
a tubular base body;
a first fastening element on a first end of the base body, the first fastening element for fastening the wearing hook;
a second fastening element on or in the vicinity of a second end of the base body, the second fastening element for fastening to a frame of the hearing apparatus; and
a third fastening element arranged between the first and the second fastening element on the base body, the third fastening element for fastening to a housing shell of the hearing apparatus.

12. The connector as claimed in claim 11, wherein the first fastening element is part of a snap-fit or plug-in system in order to snap-fit or plug the wearing hook to the connector.

13. The connector as claimed in claim 1, with the first fastening element includes a thread in order to screw the wearing hook onto the connector.

14. The connector as claimed in claim 11, wherein the second fastening element includes a flange in order to fasten the connecting piece in a frame of the hearing apparatus.

15. The connector as claimed in claim 12, wherein the second fastening element includes a flange in order to fasten the connecting piece in a frame of the hearing apparatus.

16. The connector as claimed in claim 13, wherein the second fastening element includes a flange in order to fasten the connecting piece in a frame of the hearing apparatus.

17. The connector as claimed in claim 11, wherein the second fastening element includes a collar which can be injection-molded into a frame of the hearing apparatus.

18. The connector as claimed in claim 11, wherein the third fastening element includes a flange.

19. The connector as claimed in claim 11, wherein the connector is formed from a metal.

20. The connector as claimed in claim 11, wherein the connector is formed in two pieces, with two tubular parts, which form the base body, being fastened into or onto one another at an angle of less than 180°.

21. The connector as claimed in claim 20, wherein the connector is formed in two pieces, with two tubular parts, which form the base body, being fastened into or onto one another at an angle of less than 180°.

22. A hearing apparatus, comprising:
a frame in which signal processing components are fastened;
a wearing hook;
a housing shell; and
a connector, comprising:
a tubular base body,
a first fastening element on a first end of the base body,
a second fastening element on or in the vicinity of a second end of the base body, and
a third fastening element arranged between the first and the second fastening element on the base body,
wherein the connector is fastened to the wearing hook with the first fastening element, to the frame with the second fastening element and to the housing shell with the third fastening element.

23. The hearing apparatus as claimed in claim 22,
wherein the second fastening element has a collar and is injection-molded into the frame, and
wherein the third fastening element has a flange, onto which the housing shell is pinned.
